(19) United States
(12) Patent Application Publication
(10) Pub. No.: US 2025/0097776 A1
(43) Pub. Date: Mar. 20, 2025

(54) INFORMATION TRANSMISSION METHOD AND APPARATUS OF BACKSCATTER COMMUNICATION, TERMINAL, AND NETWORK SIDE DEVICE

(71) Applicant: VIVO MOBILE COMMUNICATION CO., LTD., Dongguan (CN)

(72) Inventors: Dongru LI, Dongguan (CN); Kai WU, Dongguan (CN)

(73) Assignee: VIVO MOBILE COMMUNICATION CO., LTD., Dongguan (CN)

(21) Appl. No.: 18/964,458

(22) Filed: Dec. 1, 2024

Related U.S. Application Data
(63) Continuation of application No. PCT/CN2023/096469, filed on May 26, 2023.

(30) Foreign Application Priority Data
Jun. 1, 2022 (CN) 202210624327.0

(51) Int. Cl. H04W 28/18

(52) U.S. Cl. CPC H04W 28/18

(57) ABSTRACT

A method for information transmission of backscatter communication, a terminal, and a network side device are provided. The method includes: the terminal sends first information to the network side device, where the first information is used for configuration update or transmission adjustment related to backscatter communication, and the first information includes at least one of the following: inventory-related information; information related to backscattering of a backscatter device; or information related to a carrier wave or a control command.

### CROSS-REFERENCE TO RELATED APPLICATION

This application is a continuation of International Application No. PCT/CN2023/096469, filed May 26, 2023, which claims priority to Chinese Patent Application No. 202210624327.0, filed Jun. 1, 2022. The entire contents of each of the above-referenced applications are expressly incorporated herein by reference.

### TECHNICAL FIELD

This application relates to the field of communication technologies, and in particular, to an information transmission method and apparatus of backscatter communication, a terminal, and a network side device.

### BACKGROUND

In a backscatter communication scenario, due to a dynamic change in a quantity of backscatter devices (for example, tags) and uncertainty of a channel state, there may be situations such as misdetection or missed detection of a backscatter communication channel or signal. If the error situation cannot be corrected in time, communication efficiency and reliability in backscatter communication may be reduced.

### SUMMARY

Embodiments of this application provide an information transmission method and apparatus of backscatter communication, a terminal, and a network side device.

According to a first aspect, an information transmission method of backscatter communication is provided, including:

A terminal sends first information to a network side device. The first information is used for configuration update and/or transmission adjustment related to backscatter communication. The first information includes at least one of the following:
inventory-related information;
information related to backscattering of a backscatter device; or
information related to a carrier wave and/or a control command.

According to a second aspect, an information transmission method of backscatter communication is provided, including:

A network side device receives first information sent by a terminal participating in backscatter communication; and
the network side device performs configuration update and/or transmission adjustment related to backscatter communication based on the first information.

The first information includes at least one of the following:
inventory-related information;
information related to backscattering of a backscatter device; or
information related to a carrier wave and/or a control command.

According to a third aspect, an information transmission apparatus of backscatter communication is provided, including:
a sending module, configured to send first information to a network side device. The first information is used for configuration update and/or transmission adjustment related to backscatter communication. The first information includes at least one of the following:
inventory-related information;
information related to backscattering of a backscatter device; or
information related to a carrier wave and/or a control command.

According to a fourth aspect, an information transmission apparatus of backscatter communication is provided, including:
a receiving module, configured to receive first information sent by a terminal participating in backscatter communication; and
a processing module, configured to perform configuration update and/or transmission adjustment related to backscatter communication based on the first information.

The first information includes at least one of the following:
inventory-related information;
information related to backscattering of a backscatter device; or
information related to a carrier wave and/or a control command.

According to a fifth aspect, a terminal is provided. The terminal includes a processor and a memory. The memory stores a program or instructions executable on the processor. When the program or the instructions are executed by the processor, the steps of the method according to the first aspect are implemented.

According to a sixth aspect, a terminal is provided, including a processor and a communication interface. The communication interface is configured to send first information to a network side device. The first information is used for configuration update and/or transmission adjustment related to backscatter communication. The first information includes at least one of the following:
inventory-related information;
information related to backscattering of a backscatter device; or
information related to a carrier wave and/or a control command.

According to a seventh aspect, a network side device is provided. The network side device includes a processor and a memory. The memory stores a program or instructions executable on the processor. When the program or the instructions are executed by the processor, the steps of the method according to the second aspect are implemented.

According to an eighth aspect, a network side device is provided, including a processor and a communication interface. The communication interface is configured to receive first information sent by a terminal participating in backscatter communication. The processor is configured to perform configuration update and/or transmission adjustment related to backscatter communication based on the first information.

The first information includes at least one of the following:
inventory-related information;
information related to backscattering of a backscatter device; or
information related to a carrier wave and/or a control command.

According to a ninth aspect, a communication system is provided, including: a terminal and a network side device. The terminal may be configured to perform the steps of the method according to the first aspect. The network side device may be configured to perform the steps of the method according to the second aspect.

According to a tenth aspect, a readable storage medium is provided. The readable storage medium stores a program or instructions. When the program or the instructions are executed by a processor, the steps of the method according to the first aspect are implemented, or the steps of the method according to the second aspect are implemented.

According to an eleventh aspect, a chip is provided. The chip includes a processor and a communication interface. The communication interface is coupled to the processor. The processor is configured to run a program or instructions to implement the method according to the first aspect or implement the method according to the second aspect.

According to a twelfth aspect, a computer program/a program product is provided. The computer program/the program product is stored in a storage medium. The computer program/the program product is executed by at least one processor to implement the steps of the method according to the first aspect or implement the steps of the method according to the second aspect.

In embodiments of this application, the terminal participates in backscatter communication, and the terminal sends the first information for assisting backscatter communication to the network side device, so that the network side device quickly performs configuration update and/or transmission adjustment related to backscatter communication, thereby improving efficiency of backscatter communication.

### BRIEF DESCRIPTION OF THE DRAWINGS

FIG. 1 is a block diagram of a wireless communication system to which an embodiment of this application may be applied;

FIG. 2 is a first schematic diagram of an application scenario of backscatter communication according to an embodiment of this application;

FIG. 3 is a second schematic diagram of an application scenario of backscatter communication according to an embodiment of this application;

FIG. 4 is a third schematic diagram of an application scenario of backscatter communication according to an embodiment of this application;

FIG. 5 is a first flowchart of an information transmission method of backscatter communication according to an embodiment of this application;

FIG. 6 is a second flowchart of an information transmission method of backscatter communication according to an embodiment of this application;

FIG. 7 is a schematic diagram of a scenario 1 of an example application according to an embodiment of this application;

FIG. 8 is a schematic diagram of a scenario 2 of an example application according to an embodiment of this application;

FIG. 9 is a schematic diagram of a scenario 3 of an example application according to an embodiment of this application;

FIG. 10 is a first schematic diagram of a structure of an information transmission apparatus of backscatter communication according to an embodiment of this application;

FIG. 11 is a second schematic diagram of a structure of an information transmission apparatus of backscatter communication according to an embodiment of this application;

FIG. 12 is a schematic diagram of a structure of a communication device according to an embodiment of this application;

FIG. 13 is a schematic diagram of a structure of a terminal according to an embodiment of this application; and

FIG. 14 is a schematic diagram of a structure of a network side device according to an embodiment of this application.

### DETAILED DESCRIPTION

The technical solutions in embodiments of this application are clearly described below with reference to the accompanying drawings in embodiments of this application. Apparently, the described embodiments are merely some rather than all of embodiments of this application. All other embodiments obtained by a person of ordinary skill in the art based on embodiments of this application fall within the protection scope of this application.

In the specification and claims of this application, the terms “first”, “second”, and the like are used to distinguish similar objects, but are not used to describe a specific sequence or order. It should be understood that the terms used in such a way are interchangeable in a proper case, so that embodiments of this application can be implemented in an order different from the order shown or described herein. In addition, the objects distinguished by “first” and “second” are usually of a same type, without limiting a quantity of objects. For example, there may be one or more first objects. In addition, “and/or” in the specification and the claims means at least one of the connected objects, and the character “/” generally indicates an “or” relationship between the associated objects.

It should be noted that, the technology described in embodiments of this application is not limited to a Long Term Evolution (LTE)/LTE-Advanced (LTE-A) system, and may further be used in other wireless communication systems, such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and another system. The terms “system” and “network” in embodiments of this application are often used interchangeably, and the described technologies may be used to both the systems and radio technologies mentioned above as well as to other systems and radio technologies. The following descriptions describe a New Radio (NR) system for illustrative purposes, and NR terms are used in most of the descriptions below. However, these technologies may also be applied to applications other than NR system applications, such as a 6^{th} Generation (6G) communication system.

FIG. 1 is a block diagram of a wireless communication system to which an embodiment of this application may be applied. The wireless communication system includes a terminal 11 and a network side device 12. The terminal 11 may be a terminal side device, such as a mobile phone, a tablet personal computer, a laptop computer, or referred to as a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart appliance (a home appliance with a wireless communication function, for example, a refrigerator, a television, a washing machine, or furniture), a game console, a personal computer (PC), a teller machine, or a self-service machine. The wearable device includes: a smart watch, a smart band, a smart earphone, smart glasses, smart jewelry (a smart bangle, a smart bracelet, a smart ring, a smart necklace, a smart ankle bangle, a smart anklet, or the like), a smart wristband, smart clothing, or the like. It should be noted that, a specific type of the terminal 11 is not limited in embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Network (WLAN) access point or a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or another appropriate term in the art. The base station is not limited to a specific technical term, provided that a same technical effect is achieved. It should be noted that, in embodiments of this application, a base station in an NR system is merely used as an example, and a specific type of the base station is not limited.

The following describes in detail an information transmission method and apparatus of backscatter communication, a terminal, and a network side device provided in embodiments of this application by using some embodiments and application scenarios thereof with reference to the accompanying drawings.

Backscatter refers to information transmission by a backscatter device using a radio frequency signal from another device or an environment to modulate a signal. A backscatter communication device may be:
a passive tag, which is a passive IoT device (Passive-IoT) device;
a semi-passive tag, which has a specific amplification capability for downlink reception or uplink reflection; or
a tag having an active transmission capability (active Tag), which can send information to a reader without relying on reflection of an incident signal.

In this embodiment, an example in which the backscatter device is a tag is used for description.

A design of a conventional Radio Frequency Identification (RFID) technology requires, in an inventory mode, an interrogator to send a query instruction (Query), and the tag replies (Reply), to be specific, generates a 16-bit random number to the interrogator. Then the interrogator sends the sequence to the tag through an ACK instruction, and the tag sends related data to the reader.

In an existing backscatter communication system, the reader can usually receive a backscattering signal of only one tag at a moment. For example, in an RFID inventory process, when the reader sends a control command to start the inventory process, a value Q may be indicated. The tag randomly selects a value q from locally generated values of {0, . . . , 2^{Q-1}}. A tag whose current random value is 0 may respond to the control command of the reader and transmit a backscattering signal. A tag whose current random value is not 0 may temporarily not transmit a backscattering signal. After completing communication with the tag whose random value is 0, the reader can continue to send a control command (for example, repeat query queryRep), for example, to instruct the tag to reduce a generated random number by 1. A tag whose random value is reduced to 0 responds to the control command and performs backscatter transmission.

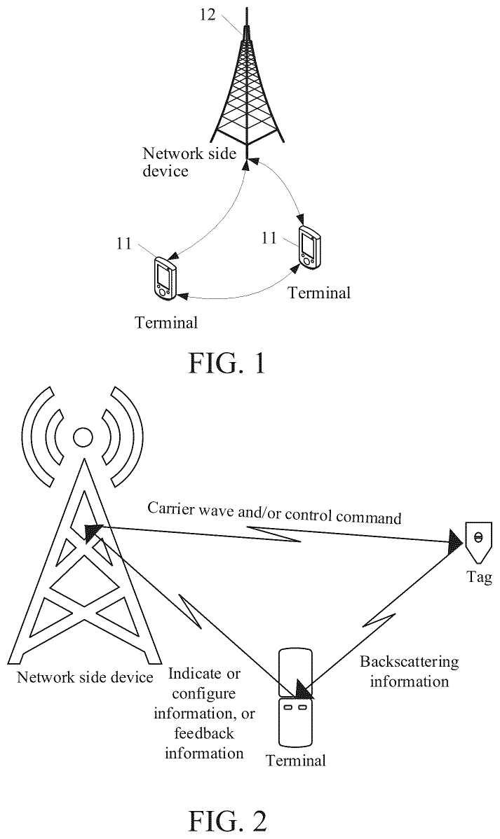

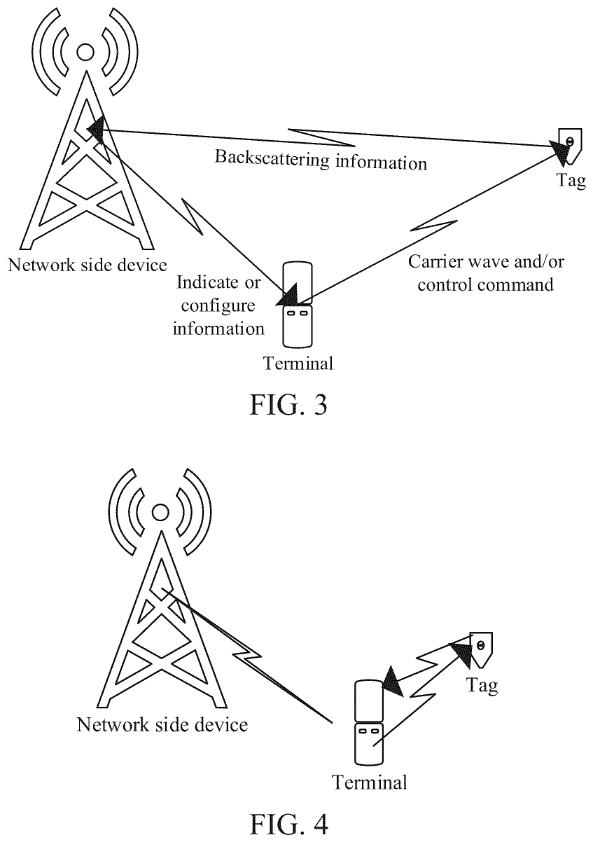

It should be noted that, an application scenario of backscatter communication in which a terminal participates provided in embodiments of this application is shown in FIG. 2 to FIG. 4, but a scenario to which embodiments of this application is applicable is not limited thereto. In FIG. 2, a network side device sends a carrier wave and a control command to a backscatter device (for example, a tag), and a terminal receives backscattering information reflected by the tag. In FIG. 3, the terminal sends a carrier wave and a control command to the tag. The network side device receives backscattering information reflected by the tag. A command type includes at least one of the following: select, inventory, or access. In FIG. 4, the terminal sends a carrier wave and a control command to the tag, and receives a backscattering signal from the tag. The network side device may perform some backscatter communication configurations and the like. This is not limited herein.

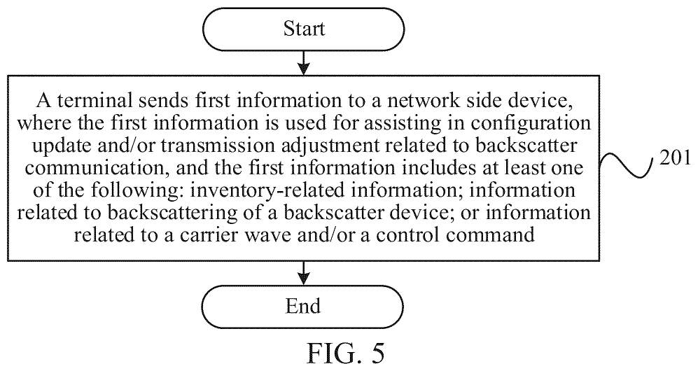

As shown in FIG. 5, an embodiment of this application provides an information transmission method of backscatter communication, including:

Step 201: A terminal sends first information to a network side device, where the first information is used for configuration update and/or transmission adjustment related to backscatter communication, and the first information includes at least one of the following:
inventory-related information;
information related to backscattering of a backscatter device; or
information related to a carrier wave and/or a control command.

In at least one embodiment of this application, backscatter communication may be understood as transmission of a backscattering channel or signal. The transmission of a backscattering channel or signal includes: (1) a carrier wave, (2) a control command, and (3) backscattering information.
(1) Carrier wave: In an embodiment, the carrier wave may be sent by the network side device to a tag, or may be sent by the terminal to a tag.
(2) Control command, for example, a select command, a query command, a repeat query command, an acknowledge command, a read command, a write command, or a random request command: In an embodiment, the control command may be sent by the network side device to a tag, or may be sent by the terminal to a tag.

In some embodiments, the control command may include at least one of the following: a select type command, a query type command, or an access command. The select type command includes at least one of the following: a select command, an inventory command, or a sort command. The query type command includes at least one of the following: a query command, a query adjust command, or a repeat query command. The access command includes at least one of the following: a random request command, a read command, a write command, a kill command, a lock command, an access command, a security-related access command, or a file management-related access command.

The select type command is essential. Because a tag has a plurality of attributes, the select type command is used based on a standard and policy set by a user. If some specific attributes and marks are changed, a specific group of tags is artificially selected or delineated, and only inventory identification or access operations can be performed on the specific group of tags. This helps reduce conflicts and repeated identification and speed up an identification process.

A command in an inventory phase is used for starting an inventory. For example, the query command is used for starting a round of inventory and determining which tags participate in the round of inventory. The Query Adjust command is used for adjusting a quantity of original receiving slots of the tag. The repeat query command is used for reducing a value of a tag slot.

In the access command (Access), the random request (Req_RN) command requires the tag to generate a random number. The read command is used for reading data from a specific location in storage of the tag. The write command is used for writing data into the storage of the tag. The kill command may be used for preventing privacy leakage and the tag may no longer be available. The lock command is used for preventing the tag from performing a writing action, to prevent data from being arbitrarily altered. The access command is used for transitioning the tag from an open state to a secure state when the tag has a password. The security-related access command is used for ensuring tag security. The file management-related access command may be used for managing a file in the tag.
(3) Backscattering information, for example, tag identification information (such as a 16-bit random number that temporarily represents a tag identity during a query process, electronic product code information, and tag state information): In an embodiment, the backscattering channel or signal may be sent by the tag to the terminal through backscatter, or may be sent by the tag to the network side device through backscatter.

In an embodiment, before the terminal sends the first information to the network side device in step 201, the method further includes:

The terminal monitors a channel or a signal used for backscatter communication.

Accordingly, step 201 includes:

The terminal sends the first information to the network side device based on a monitoring result of the channel or the signal used for backscatter communication.

In some embodiments, the channel or the signal used for backscatter communication includes: (1) a carrier wave, (2) a control command, and (3) backscattering information. For detailed explanation, refer to the foregoing descriptions of (1) the carrier wave, (2) the control command, and (3) the backscattering information. Details are not described herein.

In at least one embodiment of this application, the inventory-related information includes at least one of the following:
a recommended value of Q, where Q is a parameter used for managing a response probability of the backscatter device;
a suggested value for increasing Q;
a suggested value for reducing Q;
an expected quantity of backscatter devices that can be controlled by a control command at a time;
a recommended value of N, where the terminal reports, after each N rounds of inventory, backscattering information of the backscatter device received by the terminal to the network side device; or
a recommended inventory method.

For example, in one case, if a value of Q is too small, a probability of a plurality of backscatter devices (such as tags) locally generating a same random number may increase, resulting in a possibility of a plurality of tags performing backscatter transmission simultaneously at a specific moment. In this case, there is a high probability that a reader cannot detect a backscattering signal of any tag. In this case, the terminal may suggest, based on the first information, increasing the value of Q, or directly carry the recommended value of Q in the first information. The recommended value is greater than a current value of Q. The network side device gradually increases the value of Q during an inventory process to select a reasonable value of Q.

In another case, if a value of Q is too large, a probability of the tag selecting a value of 0 or selecting a smaller value may be reduced, resulting in a case in which no tag is found after a plurality of queries. In this case, the terminal may suggest, based on the first information, reducing the value of Q, or directly carry the recommended value of Q in the first information. The recommended value is less than a current value of Q. The network side device gradually reduces the value of Q during an inventory process to select a reasonable value of Q.

It should be noted that, a control command at a time supports controlling a backscatter device refers to: the control command at a time supports triggering a backscatter device of backscatter or the control command at a time instructs a backscatter device of backscatter.

In some embodiments, “a quantity of backscatter devices that a control command at a time is expected to act on” includes: a quantity of backscatter devices inventoried in an inventory round. The inventory round refers to a time period starting with initiation of a query command and ending with initiation of a subsequent query command or a select command or challenge command.

In this embodiment of this application, information transmission between a challenger or a reader and the tag includes:
a. Select operation: The process by which an Interrogator selects a Tag population for subsequent inventory or cryptographically challenges a Tag population for subsequent authentication. Select includes the Select and Challenge commands.
b. Inventory operation: The process by which an Interrogator identifies Tags. An Interrogator begins an inventory round by transmitting a Query command in one of four sessions. One or more Tags may reply. The Interrogator detects a single Tag reply and requests the PC (protocol control), optional XPC (Extended Protocol Control) word(s), EPC, and CRC-16 from the Tag. An inventory round operates in one and only one session at a time. Inventory includes a plurality of commands, among which very important command is a query-related command, such as a query command and a repeat query command.
c. Access operation: The process by which an Interrogator transacts with (reads, writes, authenticates, or otherwise engages with) an individual Tag. An Interrogator singulates and uniquely identifies a Tag prior to access. Access includes a plurality of commands.

In some embodiments, commands between the challenger and the tag are shown in Table 1.

TABLE 1

| Operation | | |
|---|---|---|
| type | Instruction | Function |
| Select | Select | Select a tag. Select to allow the challenger to select a group of |
| | | tags for subsequent inventory. |
| | Challenge | Challenge allows the challenger to challenge a group of tags |
| | | for subsequent authentication. |
| Inventory | Query | Start an inventory. To be specific, initiate an inventory round |
| | | and determine which tags participate in the inventory round. |
| | | Query includes a slot-count parameter Q. After receiving |
| | | Query, the tag selects a random value in a range of (0, 2^{Q-1}) |
| | | and load the value into a slot counter of the tags. The tag |
| | | selects zero to transition to a reply state. The tag selects a non- |
| | | zero value to transition to an arbitrate state. |
| | Query adjust | Adjust a quantity of original slots of the tag. |
| | Repeat query | The tag may reduce a number of a slot of the tag. |
| | (QueryRep) | |
| | Electronic product | It is an instruction that an interrogator may reply to the tag, |
| | code | and the tag may backscatter an RN16. |
| | acknowledgment | |
| | (ACK) | |
| | Negative | Instruction issued by the interrogator. The tag returns to the |
| | Acknowledgment | arbitrate (Arbitrate) state. At any point the Interrogator may |
| | (Negative | issue a NAK, in response to which all Tags in the inventory |
| | Acknowledgment, | round that receive the NAK return to arbitrate without |
| | NAK) | changing their inventoried flag. |
| Access | Random request | Require the tag to generate a random number. |
| | (Req_RN) | |
| | Read | Read data from a specific location in storage of the tag. |
| | Write | Write data into the storage of the tag. |
| | Kill | No longer respond to any interrogator. |
| | | Prevent privacy leakage. |
| | | The tag is no longer available. |
| | Lock | The tag can no longer perform a writing action. |
| | | Prevent data from being arbitrarily altered. |
| | Access (optional) | Transition the tag from an open state to a secure state when |
| | | the tag has a password. |
| | Block write | Write a plurality of blocks at a time. |
| | (optional) | |
| | Lock erase | Erase a plurality of blocks from single tagged storage. |
| | (optional) | |
| | Authenticate, | Security-related access command. |
| | Secure | An Authenticate command may implement Tag, Interrogator, |
| | Communication | and/or mutual authentication, depending on the Tag's |
| | (SecureComm), | implementation of the cryptographic suite specified by CSI in |
| | Authentication | the command. |
| | Communication | An AuthComm command allows authenticated R⇒T |
| | (AuthComm), | communications. |
| | Key Update | A SecureComm command allows secure R⇒T |
| | (KeyUpdate), and | communications. |
| | Tag Privilege | A KeyUpdate command allows an authenticated Interrogator |
| | (TagPrivilege). | to write or change a key. |
| | | A TagPrivilege command allows an Interrogator to read or |
| | | modify the privileges for the access password or for a key, |
| | | respectively. (An Authenticate command may implement Tag, |
| | | Interrogator, and/or mutual authentication, depending on the |
| | | Tag's implementation of the cryptographic suite specified by |
| | | CSI in the command. |
| | | An AuthComm command allows authenticated R⇒T |
| | | communications. |
| | | A SecureComm command allows secure R⇒T |
| | | communications. |
| | | A KeyUpdate command allows an authenticated Interrogator |
| | | to write or change a key. |
| | | A TagPrivilege command allows an Interrogator to read or |
| | | modify the privileges for the access password or for a key, |
| | | respectively). |
| | File open | Access-related command for file management. |
| | (FileOpen), File | The file-management access commands are FileOpen, |
| | list (FileList), File | FileList, FileSetup, and FilePrivilege. |
| | privilege | A FileOpen command allows an Interrogator to open a file. |
| | (FilePrivilege), | A FileList command allows an Interrogator to determine the |
| | and File setup | existence of, size of, attributes of, and its privileges to, one or |
| | (FileSetup). | more files. |
| | | A FileSetup command allows an Interrogator to change the |
| | | FileType for, and/or resize, the currently open file. |
| | | A FilePrivilege command allows an Interrogator to read or |
| | | alter the privileges (see below) granted by the currently open |
| | | file to the open state, access password, or a key. |
| | | (The file-management access commands are FileOpen, |
| | | FileList, FileSetup, and FilePrivilege. |
| | | A FileOpen command allows an Interrogator to open a file. |
| | | A FileList command allows an Interrogator to determine the |
| | | existence of, size of, attributes of, and its privileges to, one or |
| | | more files. |
| | | A FileSetup command allows an Interrogator to change the |
| | | FileType for, and/or resize, the currently open file. |
| | | A FilePrivilege command allows an Interrogator to read or |
| | | alter the privileges (see below) granted by the currently open |
| | | file to the open state, access password, or a key). |
| | Random request | Core access command. |
| | (Req_RN), Read, | The core access commands are Req_RN, Read, Write, Lock, |
| | Write, Lock, Kill, | Kill, Access, BlockWrite, BlockErase, BlockPermalock, and |
| | Access, Block | Untraceable. Req_RN, Read, Write, Lock, and Kill are |
| | write | mandatory. Access, BlockWrite, BlockErase, |
| | (Block Write), | BlockPermalock, and Untraceable are optional. A Tag may |
| | Block erase | implement one or more of the optional commands regardless |
| | (BlockErase), | of whether the Tag supports cryptographic security or file |
| | Block permalock | management. |
| | (BlockPermalock), | The Write, BlockWrite, and BlockErase commands allow an |
| | and Untraceable | Interrogator to write or erase portions of Tag memory. |
| | (Untraceable). | The Lock and BlockPermalock commands allow an |
| | | Interrogator to configure portions of Tag memory to be |
| | | changeably or permanently writeable or unwriteable. |
| | | The Untraceable command allows an Interrogator with an |
| | | asserted Untraceable privilege. |
| | | (The core access commands are Req_RN, Read, Write, Lock, |
| | | Kill, Access, BlockWrite, BlockErase, BlockPermalock, and |
| | | Untraceable. Req_RN, Read, Write, Lock, and Kill are |
| | | mandatory. Access, BlockWrite, BlockErase, |
| | | BlockPermalock, and Untraceable are optional. A Tag may |
| | | implement one or more of the optional commands regardless |
| | | of whether the Tag supports cryptographic security or file |
| | | management. |
| | | The Write, BlockWrite, and BlockErase commands allow an |
| | | Interrogator to write or erase portions of Tag memory. |
| | | The Lock and BlockPermalock commands allow an |
| | | Interrogator to configure portions of Tag memory to be |
| | | changeably or permanently writeable or unwriteable. |
| | | The Untraceable command allows an Interrogator with an |
| | | asserted Untraceable privilege). |

Various states of the tag are shown in Table 2.

TABLE 2

| State | |
|---|---|
| of the tag | Description |
| Ready | Not in a current inventory operation. |
| Arbitrate | The tag is currently in an inventory operation. |
| | It indicates that a slot corresponding to the tag is not |
| | zero, indicating that the tag is still waiting. |
| Reply | Generate a 16-bit random number for the interrogator. |
| | A state in which the tag acknowledges when receiving an |
| | ACK command. |
| | A state in which the tag returns to arbitration when not |
| | receiving an ACK command or receiving a NAK |
| | command. |
| Acknowledge | From this state to any state other than a killed state. |
| Open | When a tag with a non-zero password receives a random |
| | request instruction when the tag is in an acknowledge |
| | state. |
| Secure | When a tag with a zero password receives a random |
| | request instruction sent by the interrogator when the tag |
| | is in an acknowledge state. |
| Killed | Permanently unavailable. |

Q in an inventory operation may be understood as: a parameter used by the challenger to adjust a response probability of the tag. The challenger instructs tags in an inventory round to load a Q-bit random (or pseudo-random) number into insertion slot counters of the tags. The challenger can also command the tags to reduce slot counters of the tags. The tags may reply when a value in the slot counters (namely, slots) of the tags is zero. Q is an integer in a range of (0,15). A corresponding response probability of the tag ranges from 1 to 0.000031. Simply, a value of Q is used for controlling a tag population in an inventory.

A slot corresponds to a point in an inventory round to which the tag may respond. The slot is a value output by the slot counter of the tag. The tag replies when the slot (namely, a value in the slot counter) of the tag is zero. In some embodiments, the slot refers to a value randomly selected by the tag from 0 to 2^{Q-1} based on the value of Q. Only when a specific slot value, for example, slot=0, is selected, the tag can receive a next command.

In an embodiment, the recommended inventory method includes at least one of the following:
inventory of a single backscatter device;
inventory of a plurality of backscatter devices; or
whether the terminal participates in sending a specific control command to assist the network side device in performing inventory of a backscatter device.

In an embodiment, when the terminal continuously or cumulatively fails to successfully receive backscattering information for more than a specific number of times within a specific time period, the terminal recommends that the network side device uses the inventory method of a single backscatter device, to improve accuracy of the terminal receiving the backscattering information, so that robustness of backscatter communication is improved.

In some embodiments, the foregoing control command may be a command such as an ACK command or a NAK command. For specific uses of the ACK command and the NAK command, refer to the descriptions of the foregoing commands. Details are not described herein again.

It should be noted that, the inventory of a single backscatter device refers to that one inventory command is only expected to inventory one backscatter device. The inventory of a plurality of backscatter devices refers to that one inventory command is expected to inventory a plurality of backscatter devices.

In another embodiment, the information related to backscattering of a backscatter device includes at least one of the following:
information on reception of backscattering information of the backscatter device; or
transmission parameter adjustment information of the backscatter device.

In some embodiments, the information on reception of backscattering information of the backscatter device includes at least one of the following:
statistics of a number of times of unsuccessful receptions of the backscattering information; total number of times of unsuccessful receptions of the backscattering information;
statistics of a number of times of successful receptions of the backscattering information; total number of times of successful receptions of the backscattering information; or
reason information of unsuccessful reception of the backscattering information. For example, a cause may include: a backscatter conflict between backscatter devices, no backscattering information of the backscatter device being detected, and the like.

In some embodiments, the number of times of unsuccessful receptions of the backscattering information includes: a number of times of unsuccessful receptions of the backscattering information within a time interval, a number of times of unsuccessful receptions of the backscattering information in an inventory round, or the like. This is not limited herein. In addition, the number of times of successful receptions of the backscattering information may be understood in a similar way to the number of times of unsuccessful receptions of the backscattering information.

In still another embodiment, the information related to a carrier wave and/or a control command includes at least one of the following:
transmission parameter adjustment information of the carrier wave and/or the control command; or
format adjustment information of the control command.

The transmission parameter adjustment information includes: a recommended value of a transmission parameter, and/or a recommended adjustment strategy for the transmission parameter (For example, raising or increasing the transmission parameter according to a preset rule, or lowering or reducing the transmission parameter according to a preset rule).

In some embodiments, the transmission parameter includes at least one of the following:
a time domain resource;
a frequency domain resource;
a transmitting power;
a transmitting frequency band;
a center frequency;
a modulation scheme, such as double sideband amplitude shift keying (DSB-ASK), single sideband amplitude shift keying (SSB-ASK), and phase reversal amplitude shift keying (PR-ASK); or
an encoding mode.

In another embodiment, the format adjustment information of the control command includes at least one of the following:
a recommended channel length of the control command, for example, a long form or a short form;
a recommended code rate of control command encoding; or
a recommended encoding mode of the control command, in other words, which encoding mode is recommended.

It should be noted that, the terminal may further determine transmission quality of a downlink channel based on reception of the carrier wave and/or the control command and reception of a preamble, and feed back the transmission quality to the network side device. The transmission quality may be an indicator such as Reference Signal Received Power (RSRP), Reference Signal Received Quality (RSRQ), Received Signal Strength Indication (RSSI), a Signal to Interference plus Noise Ratio (SINR), and Channel State Information (CSI).

In at least one embodiment of this application, a type of the first information is at least one of a Buffer State Report (BSR), a Scheduling Request (SR), and a UE assistance information (UAI);
and/or
the first information is carried by an uplink resource which is configured by a high layer or dynamically indicated, for example, the first information is transmitted on a physical uplink control channel PUCCH resource or a physical uplink shared channel PUSCH resource which is configured by a high layer or dynamically indicated.

In at least one embodiment of this application, step 201 includes:

The terminal periodically sends the first information to the network side device. In some embodiments, a network side device configures reporting period information of the first information;
and/or step 201 includes:

The terminal sends the first information to the network side device, which is triggered based on the expiry of a first timer.

In some embodiments, during the running of the first timer, the terminal does not send the first information, and/or in a case that the terminal sends the first information, the first timer is restarted;
and/or step 201 includes:

The terminal sends the first information to the network side device, which is triggered based on a first event. In some embodiments, the first event includes any one of the following:
continuously or cumulatively receiving M1 pieces of backscattering information;
continuously or cumulatively receiving backscattering information for N1 times;
continuously or cumulatively receiving M2 pieces of backscattering information within a first time interval;
continuously or cumulatively receiving backscattering information for N2 times within the first time interval;
M3 pieces of continuous or cumulative unsuccessfully received backscattering information;
N3 times of continuously or cumulatively unsuccessfully receiving backscattering information;
M4 pieces of continuous or cumulative unsuccessfully received backscattering information within a second time interval; or
N4 times of continuously or cumulatively unsuccessfully receiving backscattering information within the second time interval.
M1, M2, M3, M4, N1, N2, N3, and N4 are respectively integers greater than or equal to 1.

In an embodiment, according to a running rule of the first timer, the terminal can periodically send the first information to the network side device. A period is equal to duration of the first timer.

In some embodiments, the M1, M2, M3, or M4 pieces of backscattering information respectively corresponds to M1, M2, M3 or M4 backscatter devices (for example, M1 Tags).

In some embodiments, the backscattering information may include backscattering information of one or more backscatter devices.

In some embodiments, every reception (including successful reception or unsuccessful reception) of the backscattering information may include reception of the backscattering information of one or more backscatter devices.

In some embodiments, a transmission resource of the first information configured by the network side device includes: a time domain resource, a frequency domain resource, and the like.

In some embodiments, the first timer is configured by the network side device.

In some embodiments, the first event is configured by a network side device. In other words, the network side device configures the first event that triggers reporting of the first information.

It should be noted that, the receiving in embodiments may be understood as monitoring or detecting.

In some embodiments, the received M1 and/or M2 pieces of backscattering information include: unsuccessfully received tag backscattering information and successfully received tag backscattering information.

In some embodiments, the receiving may include at least one of continuous receiving or cumulative receiving.

In summary, in this embodiment of this application, the terminal sends the first information for assisting backscatter communication to the network side device, so that the network side device quickly performs configuration update and/or transmission adjustment related to backscatter communication, so as to adjust an inventory process more quickly, thereby improving inventory efficiency.

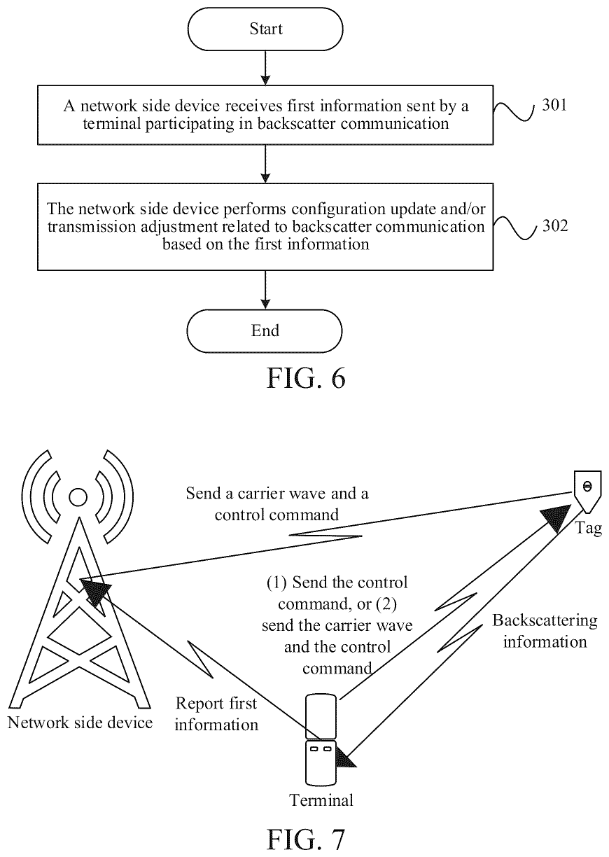

As shown in FIG. 6, an embodiment of this application further provides an information transmission method of backscatter communication, including:

Step 301: A network side device receives first information sent by a terminal participating in backscatter communication.

Step 302: The network side device performs configuration update and/or transmission adjustment related to backscatter communication based on the first information.

The first information includes at least one of the following:
inventory-related information;
information related to backscattering of a backscatter device; or
information related to a carrier wave and/or a control command.

In at least one embodiment of this application, backscatter communication includes transmission of a backscattering channel or signal: (1) transmission of a carrier wave, (2) transmission of a control command, and (3) transmission of backscattering information.
(1) The carrier wave is transmitted through a carrier channel or signal, such as an excitation signal, and may be referred to as CW for short (carrier wave). In an embodiment, the carrier channel or signal may be information sent by the network side device to a tag, or may be information sent by the terminal to a tag.
(2) The control command is transmitted through a control channel or signal, for example, a select signal, a query signal, a repeat query signal, an acknowledge signal, a read signal, a write signal, and a random request signal. In an embodiment, the control channel or signal may be information sent by the network side device to a tag, or may be information sent by the terminal to a tag.
(3) The backscattering information is transmitted through a backscattering channel or signal, for example, tag identification information (such as a 16-bit random number that temporarily represents a tag identity during a query process, electronic product code information, and tag state information): In an embodiment, the backscattering channel or signal may be information sent by the tag to the terminal through backscatter, or may be information sent by the tag to the network side device through backscatter.

In at least one embodiment of this application, the inventory-related information includes at least one of the following:
a recommended value of Q, where Q is a parameter used for managing a response probability of the backscatter device;
a suggested value for increasing Q;
a suggested value for reducing Q;
an expected quantity of backscatter devices that can be controlled by a control command at a time;
a recommended value of N, where the terminal reports, after each N rounds of inventory, backscattering information of the backscatter device received by the terminal to the network side device; or
a recommended inventory method.

It should be noted that, for a quantity of backscatter devices that a control command is expected to act on at a time, acting on refers to: triggering backscatter or instructing.

In some embodiments, “a quantity of backscatter devices that a control command at a time is expected to act on” includes: a quantity of backscatter devices inventoried in an inventory round. The inventory round refers to a time period starting with initiation of a query command and ending with initiation of a subsequent query command or a select command (select command or challenge command).

In an embodiment, the recommended inventory method includes at least one of the following:
inventory of a single backscatter device;
inventory of a plurality of backscatter devices; or
whether the terminal participates in sending a specific control command to assist the network side device in performing inventory of a backscatter device.

In some embodiments, the foregoing control command may be a command such as an ACK command or a NAK command.

It should be noted that, the inventory of a single backscatter device refers to that one inventory command is only expected to inventory one backscatter device. The inventory of a plurality of backscatter devices refers to that one inventory command is expected to inventory a plurality of backscatter devices.

In another embodiment, the information related to backscattering of a backscatter device includes at least one of the following:
information on reception of backscattering information of the backscatter device; or
transmission parameter adjustment information of the backscatter device.

In some embodiments, the information on reception of backscattering information of the backscatter device includes at least one of the following:
statistics of a number of times of unsuccessful receptions of the backscattering information;
statistics of a number of times of successful receptions of the backscattering information; or
reason information of unsuccessful reception of the backscattering information. For example, a cause may include: a backscatter conflict between backscatter devices, no backscattering information of the backscatter device being detected, and the like.

In some embodiments, the number of times of unsuccessful receptions of the backscattering information includes: a number of times of unsuccessful receptions of the backscattering information within a time interval, a number of times of unsuccessful receptions of the backscattering information in an inventory round, or the like. This is not limited herein. In addition, the number of times of successful receptions of the backscattering information may be understood in a similar way to the number of times of unsuccessful receptions of the backscattering information.

In still another embodiment, the information related to a carrier wave and/or a control command includes at least one of the following:
transmission parameter adjustment information of the carrier wave and/or the control command; or
format adjustment information of the control command.

The transmission parameter adjustment information includes: a recommended value of a transmission parameter, and/or a recommended adjustment strategy for the transmission parameter (For example, raising or increasing the transmission parameter according to a preset rule, or lowering or reducing the transmission parameter according to a preset rule).

In some embodiments, the transmission parameter includes at least one of the following:
a time domain resource;
a frequency domain resource;
a transmitting power;
a transmitting frequency band;
a center frequency;
a modulation scheme, such as double sideband amplitude shift keying (DSB-ASK), single sideband amplitude shift keying (SSB-ASK), and phase reversal amplitude shift keying (PR-ASK); or
an encoding mode.

In another embodiment, the format adjustment information of the control command includes at least one of the following:
a recommended channel length of the control command, for example, a long form or a short form;
a recommended code rate of control command encoding; or
a recommended encoding mode of the control command, in other words, which encoding mode is recommended.

It should be noted that, the terminal may further determine transmission quality of a downlink channel based on reception of the carrier wave and/or the control command and reception of a preamble, and feed back the transmission quality to the network side device. The transmission quality may be an indicator such as reference signal received power (RSRP), reference signal received quality (RSRQ), received signal strength indication (RSSI), a signal to interference plus noise ratio (SINR), and channel state information (CSI).

In summary, in this embodiment of this application, the terminal is used as a tag feedback receive end of backscatter communication, and the terminal sends the first information for assisting backscatter communication to the network side device, so that the network side device performs configuration update and/or transmission adjustment related to backscatter communication, so as to adjust an inventory process more quickly, thereby improving inventory efficiency.

To describe the information transmission method provided in embodiments of this application more clearly, several examples are provided below for description.

In a first example, UE reports inventory-related information in a scenario 1 and a scenario 2.

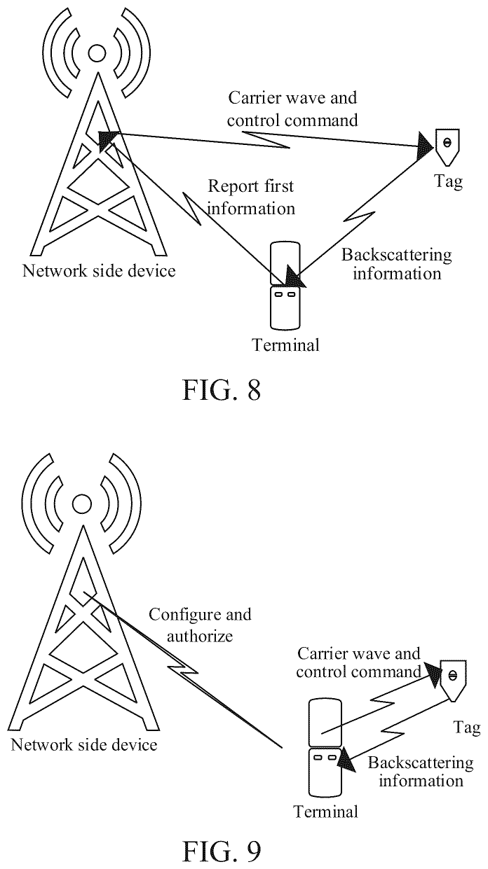

As shown in FIG. 7, the scenario 1 is that the UE may participate in sending a command (control command) and/or a Carrier Wave (CW). As shown in FIG. 8, the scenario 2 is that the UE only performs reception feedback and does not participate in transmission.

As shown in FIG. 7 and FIG. 8, in backscatter communication in which the terminal participates, the network side device (for example, a base station gNB) is used as a reader and indicates a value of Q to the tag when sending a query to start the inventory process. The value of Q is a parameter used by the reader/interrogator to control a response probability of the tag. The tag randomly generates a value in a range of {0, . . . , 2^{Q-1}} locally based on the value of Q and writes the value into a slot counter (slot counter) of the tag. The value of Q is an integer in a range of, for example, {0, 15}. Therefore, a corresponding response probability of the tag ranges from 2⁰=1 to 2⁻¹⁵=0.000031. The slot is a number of points that the tag responds to during the inventory round. Currently, only a tag whose current slot is a specific value (for example, slot=0) may respond to the control command of the reader and feed back information through backscatter. A tag whose slot value is not 0 may temporarily not perform backscatter, in other words, not feed back information.

The foregoing process is a process of random multiple access. In one case, if a value of Q is too small, a probability of a plurality of tags locally generating a same random number may increase, resulting in a possibility of a plurality of tags performing backscatter transmission simultaneously at a specific moment. In this case, there is a high probability that a reader cannot detect a backscattering signal of any tag. In another case, if a value of Q is too large, a probability of the tag selecting a value of 0 or selecting a smaller value may be reduced, resulting in a case in which no tag is found after a plurality of queries. Therefore, the gNB needs to gradually adjust the value of Q during the inventory process to select a reasonable value of Q.

Due to three-party communication, the UE, as a receiver of tag feedback information, can report some assistance information in time based on tag feedback to help the gNB quickly adjust some parameter values, including the value of Q. In addition, with reference to different inventory processes, the terminal may place some other useful information in assistance information to help the base station make a determination, or directly instruct the base station how to configure or select an inventory method.

A reporting triggering mode of the terminal for such information may be to perform periodic reporting based on a reporting resource periodically configured by the network side device. In some embodiments, the network side device configures the first timer for the UE and specifies that: no reporting is allowed during running time of the first timer, and the assistance information is reported after the first timer expires and the timer is restarted. Therefore, the terminal can report the assistance information after the timer expires. In addition, in another manner, the assistance information may be reported non-periodically by event triggering. The foregoing three reporting manners may be configured at the same time, and the terminal may independently select a reporting manner, or the network side device may specify a reporting manner.

In a second example, UE reports tag backscatter-related information in the scenario 1 and a scenario 3.

As shown in FIG. 7, the scenario 1 is that the UE may participate in sending a command (control command) and/or a CW (carrier wave). As shown in FIG. 9, the scenario 3 is that the network side device authorizes the terminal and the tag to perform BSC communication.

As shown in FIG. 7 and FIG. 9, in backscatter communication in which the terminal participates, the terminal, as a receive end to which the tag feed back through backscatter, may report some UE-side statistics to the network side device based on reception of tag feedback, for example, reporting a number of times of reception errors and/or causes of the errors of tag feedback information received by a UE side within a time period.

Moreover, in addition to reporting the foregoing statistics of the reception of the tag feedback, the UE may combine strength of a received tag reflection signal, or a detected wireless environment of a carrier CW transmission frequency, such as time-frequency domain interference, to report/trigger/notify the network side device to adjust the tag by sending a parameter, for example, changing a modulation scheme and encoding mode of the tag feedback, to improve transmission performance of a backscatter link.

In a third example, UE reports information related to a carrier wave and/or a control command in the scenario 1 and the scenario 2.

As shown in FIG. 7, the scenario 1 is that the UE may participate in sending a command and/or a CW. As shown in FIG. 8, the scenario 2 is that the UE only performs reception feedback and does not participate in transmission. In some embodiments, in the scenario 2, the UE may perform channel measurement by receiving a command and/or a CW sent by the network side device.

For example, the UE may evaluate transmission reliability of a command sent downlink based on reception or measurement of the carrier wave or the control command, and feed back to the network side device to adjust an encoding format. If channel quality is good and previous tag feedback can be received correctly, it means that the channel quality is great. It can be suggested that the network side device uses a short-format command for transmission to improve efficiency. Otherwise, it is recommended that the network side device uses a long-format command. In some embodiments, another parameter may also be reported for adjustment, such as an encoding mode, a modulation scheme, and a time-frequency domain resource. This is not limited herein.

The information transmission method of backscatter communication provided in embodiments of this application may performed by an information transmission apparatus of backscatter communication. An example in which the information transmission apparatus of backscatter communication performs the information transmission method of backscatter communication is used in an embodiment of this application to describe the information transmission apparatus of backscatter communication provided in this embodiment of this application.

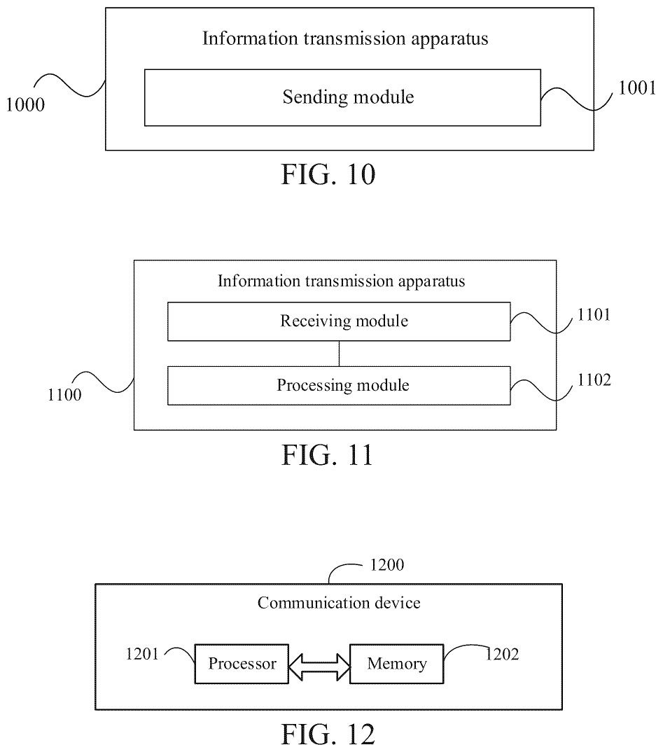

As shown in FIG. 10, an embodiment of this application further provides an information transmission apparatus 1000 of backscatter communication, including:
a sending module 1001, configured to send first information to a network side device. The first information is used for configuration update and/or transmission adjustment related to backscatter communication. The first information includes at least one of the following:
inventory-related information;
information related to backscattering of a backscatter device; or
information related to a carrier wave and/or a control command.

In an embodiment, the inventory-related information includes at least one of the following:
a recommended value of Q, where Q is a parameter used for managing a response probability of the backscatter device;
a suggested value for increasing Q;
a suggested value for reducing Q;
an expected quantity of backscatter devices that can be controlled by a control command at a time;
a recommended value of N, where the terminal reports, after each N rounds of inventory, backscattering information of the backscatter device received by the terminal to the network side device; or
a recommended inventory method.

In an embodiment, the recommended inventory method includes at least one of the following:
inventory of a single backscatter device;
inventory of a plurality of backscatter devices; or
whether the terminal participates in sending a specific control command to assist the network side device in performing inventory of a backscatter device.

In an embodiment, the information related to backscattering of a backscatter device includes at least one of the following:
information on reception of backscattering information of the backscatter device; or
transmission parameter adjustment information of the backscatter device.

In an embodiment, the information on reception of backscattering information of the backscatter device includes at least one of the following:
statistics of a number of times of unsuccessful receptions of the backscattering information;
statistics of a number of times of successful receptions of the backscattering information; or reason information of unsuccessful reception of the backscattering information.

In an embodiment, the information related to a carrier wave and/or a control command includes at least one of the following:
transmission parameter adjustment information of the carrier wave and/or the control command; or
format adjustment information of the control command.

In an embodiment, the transmission parameter adjustment information includes: a recommended value of a transmission parameter, and/or a recommended adjustment strategy for the transmission parameter.

In an embodiment, the transmission parameter includes at least one of the following: a time domain resource;
a frequency domain resource;
a transmitting power;
a transmitting frequency band;
a center frequency;
a modulation scheme; or
an encoding mode.

In an embodiment, the format adjustment information of the control command includes at least one of the following:
a recommended channel length of the control command,
a recommended code rate of control command encoding; or
a recommended encoding mode of the control command.

In an embodiment, a type of the first information is at least one of a buffer status report BSR, a scheduling request SR, or UE assistance information UAI;
and/or
the first information is carried by an uplink resource which is configured by a high layer or dynamically indicated.

In an embodiment, the sending module includes:
a first sending submodule, configured to send the first information to the network side device;
and/or
a second sending submodule, configured to send the first information to the network side device, which is triggered based on a first timer;
and/or
a third sending submodule, configured to send the first information to the network side device, which is triggered based on a first event.

In an embodiment, the first event includes any one of the following:
continuously or cumulatively receiving M1 pieces of backscattering information;
continuously or cumulatively receiving backscattering information for N1 times;
continuously or cumulatively receiving M2 pieces of backscattering information within a first time interval;
continuously or cumulatively receiving backscattering information for N2 times within the first time interval;
M3 pieces of continuous or cumulative unsuccessfully received backscattering information;
N3 times of continuously or cumulatively unsuccessfully receiving backscattering information;
M4 pieces of continuous or cumulative unsuccessfully received backscattering information within a second time interval; or
N4 times of continuously or cumulatively unsuccessfully receiving backscattering information within the second time interval.

M1, M2, M3, M4, N1, N2, N3, and N4 are respectively integers greater than or equal to 1.

In an embodiment, that the terminal sends the first information to the network side device, which is triggered based on the first timer includes:
when the first timer times out, triggering the terminal to send the first information.

When the terminal sends the first information, the first timer is started or restarted.

In this embodiment of this application, the terminal is used as a tag feedback receive end of backscatter communication, and the terminal sends the first information for assisting backscatter communication to the network side device, so that the network side device performs configuration update and/or transmission adjustment related to backscatter communication, thereby adjusting an inventory process more quickly and improving inventory efficiency.

It should be noted that, the information transmission apparatus of backscatter communication provided in this embodiment of this application is an apparatus that can perform the foregoing information transmission method of backscatter communication. All embodiments of the foregoing information transmission method of backscatter communication are applicable to the apparatus and can achieve same or similar effects.

As shown in FIG. 11, an embodiment of this application further provides an information transmission apparatus 1100 of backscatter communication, including:
a receiving module 1101, configured to receive first information sent by a terminal participating in backscatter communication; and
a processing module 1102, configured to perform configuration update and/or transmission adjustment related to backscatter communication based on the first information.

The first information includes at least one of the following:
inventory-related information;
information related to backscattering of a backscatter device; or
information related to a carrier wave and/or a control command.

In an embodiment, the inventory-related information includes at least one of the following:
a recommended value of Q, where Q is a parameter used for managing a response probability of the backscatter device;
a suggested value for increasing Q;
a suggested value for reducing Q;
an expected quantity of backscatter devices that can be controlled by a control command at a time;
a recommended value of N, where the terminal reports, after each N rounds of inventory, backscattering information of the backscatter device received by the terminal to the network side device; or a recommended inventory method.

In an embodiment, the recommended inventory method includes at least one of the following:
inventory of a single backscatter device;
inventory of a plurality of backscatter devices; or
whether the terminal participates in sending a specific control command to assist the network side device in performing inventory of a backscatter device.

In an embodiment, the information related to backscattering of a backscatter device includes at least one of the following:
information on reception of backscattering information of the backscatter device; or
transmission parameter adjustment information of the backscatter device.

In an embodiment, the information on reception of backscattering information of the backscatter device includes at least one of the following:
statistics of a number of times of unsuccessful receptions of the backscattering information;
statistics of a number of times of successful receptions of the backscattering information; or
reason information of unsuccessful reception of the backscattering information.

In an embodiment, the information related to a carrier wave and/or a control command includes at least one of the following:
transmission parameter adjustment information of the carrier wave and/or the control command; or
format adjustment information of the control command.

In an embodiment, the transmission parameter adjustment information includes: a recommended value of a transmission parameter, and/or a recommended adjustment strategy for the transmission parameter.

In an embodiment, the transmission parameter includes at least one of the following:
a time domain resource;
a frequency domain resource;
a transmitting power;
a transmit frequency band;
a center frequency;
a modulation scheme; or
an encoding mode.

In an embodiment, the format adjustment information of the control command includes at least one of the following:
a recommended channel length of the control command,
a recommended code rate of control command encoding; or
a recommended encoding mode of the control command.

In this embodiment of this application, the terminal is used as a tag feedback receive end of backscatter communication, and the terminal sends the first information for assisting backscatter communication to the network side device, so that the network side device performs configuration update and/or transmission adjustment related to backscatter communication, thereby adjusting an inventory process more quickly and improving inventory efficiency.

It should be noted that, the information transmission apparatus of backscatter communication provided in this embodiment of this application is an apparatus that can perform the foregoing information transmission method of backscatter communication. All embodiments of the foregoing information transmission method of backscatter communication are applicable to the apparatus and can achieve same or similar effects.

The information transmission apparatus of backscatter communication in this embodiment of this application may be an electronic device, for example, an electronic device having an operating system, or may be a component in an electronic device, for example, an integrated circuit or a chip. The electronic device may be a terminal, or may be a device other than the terminal. For example, the terminal may include but is not limited to a type of the terminal 11 listed above, and the another device may be a server, a Network Attached Storage (NAS), or the like. This is not specifically limited in this embodiment of this application.

The information transmission apparatus of backscatter communication provided in this embodiment of this application can implement processes implemented in the foregoing method embodiment in FIG. 1 to FIG. 9 and achieve same technical effects. To avoid repetition, details are not described herein again.

As shown in FIG. 12, an embodiment of this application further provides a communication device 1200, including a processor 1201 and a memory 1202. The memory 1202 stores a program or instructions executable on the processor 1201. For example, in a case that the communication device 1200 is a terminal, when the program or the instructions are executed by the processor 1201, the steps of the foregoing embodiments of the information transmission method of backscatter communication are implemented, and same technical effects can be achieved. In a case that the communication device 1200 is a network side device, when the program or the instructions are executed by the processor 1201, the steps of the foregoing embodiments of the information transmission method of backscatter communication are implemented, and same technical effects can be achieved. To avoid repetition, details are not described herein again.

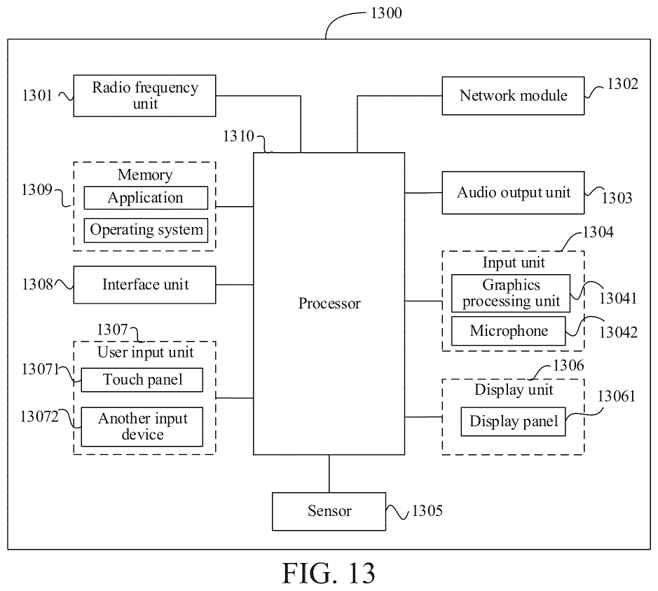

An embodiment of this application further provides a terminal, including a processor and a communication interface. The communication interface is configured to send first information to a network side device. The first information is used for configuration update and/or transmission adjustment related to backscatter communication. The first information includes at least one of the following: inventory-related information; information related to backscattering of a backscatter device; or information related to a carrier wave and/or a control command. The terminal embodiment corresponds to the foregoing terminal side method embodiment. Implementation processes and implementation methods of the foregoing method embodiments may all be applied to the terminal embodiment, and same technical effects can be achieved. FIG. 13 is a schematic diagram of a hardware structure of a terminal for implementing this embodiment of this application.

The terminal 1300 includes but is not limited to at least some components such as a radio frequency unit 1301, a network module 1302, an audio output unit 1303, an input unit 1304, a sensor 1305, a display unit 1306, a user input unit 1307, an interface unit 1308, a memory 1309, and a processor 1310.

A person skilled in the art may understand that the terminal 1300 may further include a power supply (for example, a battery) supplying power to components. The power supply may be logically connected to the processor 1310 via a power supply management system, to implement functions such as charge management, discharge management, and power consumption management by using the power supply management system. The terminal structure shown in FIG. 13 does not constitute a limitation on the terminal. The terminal may include more or fewer components than those shown in the figure, or some components are combined, or component arrangements are different. Details are not described herein again.

It should be understood that in this embodiment of this application, the input unit 1304 may include a Graphics Processing Unit (GPU) 13041 and a microphone 13042. The GPU 13041 processes image data of a still picture or video obtained by an image capture apparatus (such as a camera) in a video capture mode or an image capture mode. The display unit 1306 may include a display panel 13061. The display panel 13061 may be configured in the form of a liquid crystal display (LCD), an organic light-emitting diode (OLED), or the like. The user input unit 1307 includes at least one of a touch panel 13071 and another input device 13072. The touch panel 13071 may also be referred to as a touch screen. The touch panel 13071 may include two parts: a touch detection apparatus and a touch controller. The another input device 13072 may include, but is not limited to, a physical keyboard, a functional key (such as a volume control key or a switch key), a track ball, a mouse, and a joystick. Details are not described herein again.

In this embodiment of this application, after receiving downlink data from a network side device, the radio frequency unit 1301 may transmit the downlink data to the processor 1310 for processing. In addition, the radio frequency unit 1301 may send uplink data to the network side device. Generally, the radio frequency unit 1301 includes but is not limited to an antenna, an amplifier, a transceiver, a coupler, a low noise amplifier, a duplexer, and the like.

The memory 1309 may be configured to store a software program or instructions and various data. The memory 1309 may mainly include a first storage area for storing the program or the instructions and a second storage area for storing the data. The first storage area may store an operating system, an application or instructions (such as an audio play function and an image play function) required by at least one function, and the like. In addition, the memory 1309 may include a volatile memory or a non-volatile memory. In some embodiments, the memory 1309 may include both volatile and non-volatile memories. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch link DRAM (SLDRAM), and a Direct Rambus RAM (DRRAM). The memory 1309 in this embodiment of this application includes but is not limited to these and any other suitable types of memories.

The processor 1310 may include one or more processing units. In some embodiments, the processor 1310 integrates an application processor and a modem processor. The application processor mainly processes operations related to an operating system, a user interface, an application, and the like, and the modem processor mainly processes wireless communication signals, for example, a baseband processor. It may be understood that the modem processor may not be integrated into the processor 1310.

The radio frequency unit 1301 is configured to send first information to the network side device. The first information is used for configuration update and/or transmission adjustment related to backscatter communication. The first information includes at least one of the following:
inventory-related information;
information related to backscattering of a backscatter device; or
information related to a carrier wave and/or a control command.

In this embodiment of this application, the terminal sends the first information for assisting backscatter communication to the network side device, so that the network side device performs configuration update and/or transmission adjustment related to backscatter communication, thereby adjusting an inventory process more quickly and improving inventory efficiency.

It should be noted that, the information transmission apparatus of backscatter communication provided in this embodiment of this application is an apparatus that can perform the foregoing information transmission method of backscatter communication. All embodiments of the foregoing information transmission method of backscatter communication are applicable to the apparatus and can achieve same or similar effects.

An embodiment of this application further provides a network side device, including a processor and a communication interface. The communication interface is configured to receive first information sent by a terminal participating in backscatter communication. The processor is configured to perform configuration update and/or transmission adjustment related to backscatter communication based on the first information. The first information includes at least one of the following: inventory-related information; tag backscatter-related information; or information related to a carrier wave and/or a control command. The network side device embodiment corresponds to the foregoing network side device method embodiments. Both implementation processes and implementations of the foregoing method embodiments are applicable to the network side device embodiment, and same technical effects can be achieved.

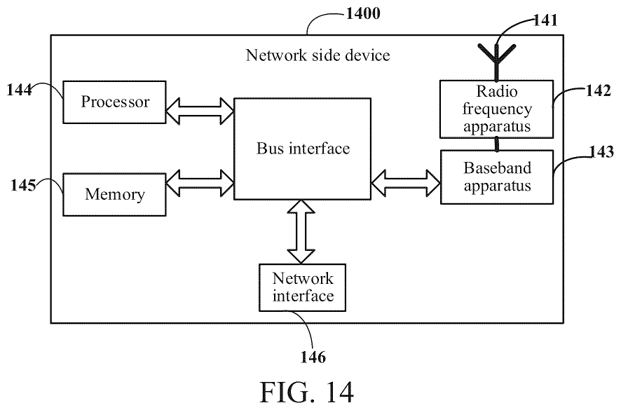

An embodiment of this application further provides a network side device. As shown in FIG. 14, the network side device 1400 includes: an antenna 141, a radio frequency apparatus 142, a baseband apparatus 143, a processor 144, and a memory 145. The antenna 141 is connected to the radio frequency apparatus 142. In an uplink direction, the radio frequency apparatus 142 receives information through the antenna 141, and sends the received information to the baseband apparatus 143 for processing. In a downlink direction, the baseband apparatus 143 processes information to be sent, and sends the processed information to the radio frequency apparatus 142. The radio frequency apparatus 142 processes the received information and then sends the processed information out through the antenna 141.

The method performed by the network side device in the foregoing embodiments may be implemented in the baseband apparatus 143. The baseband apparatus 143 includes a baseband processor.

The baseband apparatus 143 may include, for example, at least one baseband board. A plurality of chips are provided on the baseband board. As shown in FIG. 14, one of the chips is, for example, a baseband processor, and is connected to the memory 145 through a bus interface to call a program in the memory 145 so as to perform network device operations shown in the foregoing method embodiments.

The network side device may further include a network interface 146. The interface is, for example, a common public radio interface (CPRI).

The network side device 1400 in this embodiment of this application further includes: instructions or a program stored on the memory 145 and executable on the processor 144. The processor 144 calls the instructions or program in the memory 145 to execute the method executed by modules shown in FIG. 11, and achieve same technical effects. To avoid repetition, details are not described herein again.

An embodiment of this application further provides a readable storage medium. The readable storage medium stores a program or instructions. When the program or the instructions are executed by a processor, processes in the foregoing embodiments of the information transmission method of backscatter communication are implemented, and same technical effects can be achieved. To avoid repetition, details are not described herein again.

The processor is the processor in the terminal in the foregoing embodiments. The readable storage medium includes a computer-readable storage medium, for example, a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement processes in the foregoing embodiments of the information transmission method of backscatter communication and achieve same technical effects. To avoid repetition, details are not described herein again.

It should be understood that the chip mentioned in this embodiment of this application may also be referred to as a system-on-chip, a system chip, a chip system, a system-on-a-chip, or the like.

An embodiment of this application further provides a computer program/a program product, stored in a storage medium. The computer program/the program product is executed by at least one processor to implement processes in the foregoing embodiments of the information transmission method of backscatter communication and achieve same technical effects. To avoid repetition, details are not described herein again.

An embodiment of this application further provides a communication system, including: a terminal and a network side device. The terminal may be configured to perform the steps of the information transmission method of backscatter communication, and the network side device may be configured to perform the steps of the information transmission method of backscatter communication.

A person of ordinary skill in the art may notice that the exemplary units and algorithm steps described with reference to embodiments disclosed in this specification can be implemented in electronic hardware, or a combination of computer software and electronic hardware. Whether the functions are executed in a mode of hardware or software depends on particular applications and design constraint conditions of the technical solutions. A person skilled in the art may use different methods to implement the described functions for each particular application, but such implementation is not to be considered beyond the scope of the present disclosure.

A person skilled in the art may clearly understand that for convenience and conciseness of description, for specific working processes of the foregoing systems, apparatuses and units, reference may be made to the corresponding processes in the foregoing method embodiments, and details are not described herein again.

In embodiments provided in this application, it should be understood that the disclosed apparatus and method may be implemented in other manners. For example, the described apparatus embodiment is merely an example. For example, the unit division is merely a logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located at one position, or may be distributed on a plurality of network units. Some or all of the units may be selected according to actual needs to achieve the objectives of the solutions of embodiments.

In addition, functional units in embodiments of the present disclosure may be integrated into one processing unit, or each of the units may be physically separated, or two or more units may be integrated into one unit.

If implemented in the form of software functional units and sold or used as an independent product, the functions may be stored in a computer-readable storage medium. Based on such an understanding, the technical solutions of the present disclosure essentially, or the part contributing to the related art, or some of the technical solutions may be implemented in the form of a software product. The computer software product is stored in a storage medium and includes several instructions for instructing a computer device (which may be a personal computer, a server, a network device, or the like) to perform all or some of the operations of the methods described in embodiments of the present disclosure. The foregoing storage medium includes any medium that can store program code, such as a USB flash drive, a removable hard disk, a ROM, a RAM, a magnetic disk, or an optical disc.

A person of ordinary skill in the art may understand that all or some of processors of the method in the foregoing embodiments may be implemented by a computer program controlling relevant hardware. The program may be stored in a computer-readable storage medium. When the program is executed, processors of the foregoing method embodiments may be implemented. The foregoing storage medium may include a magnetic disc, an optical disc, a Read-Only Memory (ROM), a Random Access Memory (RAM), or the like.

It should be noted that, in the specification, the terms “include”, “comprise”, or any other variation thereof in this specification is intended to cover a non-exclusive inclusion. Therefore, processes, methods, objects, or apparatuses including a series of elements further includes, other than those listed, elements that are not listed or that are inherent to the processes, methods, objects, or apparatuses. Without more limitations, elements defined by the expression “including one” does not exclude that there are still other same elements in the processes, methods, objects, or apparatuses. In addition, it should be noted that the method and apparatus in embodiments of this application is not limited to performing functions in the order shown or discussed, but performing functions in a substantially simultaneous manner or in reverse order, depending on the functions, also falls within the scope thereof. For example, the described method may be performed in an order different from that described, and various steps may be added, omitted, or combined. In addition, features described in some examples may also be combined in other examples.

According to the descriptions in the foregoing embodiments, a person skilled in the art can clearly learn that the method according to the foregoing embodiment may be implemented by relying on software and a necessary general hardware platform, and may also be implemented by hardware, but in many cases, the former relates to better implementations. Based on such an understanding, the technical solutions of this application essentially, or the part contributing to the conventional technologies, may be presented in the form of a computer software product. The computer software product is stored in a storage medium (for example, a ROM/RAM, a magnetic disk, or an optical disc) including a plurality of instructions to enable a terminal (which may be a mobile phone, a computer, a server, an air conditioner, a network device, or the like) to perform the method according to embodiments of this application.

Embodiments of this application have been described above with reference to the accompanying drawings. However, this application is not limited to the foregoing specific implementations, and the foregoing specific implementations are merely examples and are not restrictive. A person of ordinary skill in the art may make various variations under the teaching of this application without departing from aims and the protection scope of the claims of this application, all of which fall within the protection scope of this application.

What is claimed is:

1. A method for information transmission of backscatter communication, comprising:
sending, by a terminal, first information to a network side device, wherein the first information is used for configuration update or transmission adjustment related to backscatter communication, and the first information comprises at least one of the following:
inventory-related information;
information related to backscattering of a backscatter device; or
information related to a carrier wave or a control command.

2. The method according to claim 1, wherein the inventory-related information comprises at least one of the following:
a recommended value of Q, wherein Q is a parameter used for managing a response probability of the backscatter device;
a suggested value for increasing Q;
a suggested value for reducing Q;
an expected quantity of backscatter devices controlled by a control command at a time;
a recommended value of N, wherein the terminal reports, after each N rounds of inventory, backscattering information received by the terminal to the network side device; or
a recommended inventory method.

3. The method according to claim 2, wherein the recommended inventory method comprises at least one of the following:
inventory of a single backscatter device;
inventory of a plurality of backscatter devices; or
whether the terminal participates in sending a specific control command to assist the network side device in performing inventory of the backscatter device.

4. The method according to claim 1, wherein the information related to backscattering of the backscatter device comprises at least one of the following:
information on reception of backscattering information of the backscatter device; or
transmission parameter adjustment information of the backscatter device.

5. The method according to claim 4, wherein the information on reception of backscattering information of the backscatter device comprises at least one of the following:
statistics of a number of times of unsuccessful receptions of the backscattering information;
statistics of a number of times of successful receptions of the backscattering information; or
reason information of unsuccessful reception of the backscattering information.

6. The method according to claim 1, wherein the information related to a carrier wave or a control command comprises at least one of the following:
transmission parameter adjustment information of the carrier wave or the control command; or
format adjustment information of the control command.

7. The method according to claim 4, wherein the transmission parameter adjustment information comprises: a recommended value of a transmission parameter, or a recommended adjustment strategy for the transmission parameter.

8. The method according to claim 7, wherein the transmission parameter comprises at least one of the following:
a time domain resource;
a frequency domain resource;
a transmitting power;
a transmitting frequency band;
a center frequency;
a modulation scheme; or
an encoding mode.

9. The method according to claim 6, wherein the format adjustment information of the control command comprises at least one of the following:
a recommended channel length of the control command;
a recommended code rate of control command encoding; or
a recommended encoding mode of the control command.

10. The method according to claim 1, wherein a type of the first information is at least one of a buffer status report (BSR), a scheduling request (SR), or UE assistance information (UAI); or
the first information is carried by an uplink resource which is configured by a high layer or dynamically indicated.

11. The method according to claim 1, wherein the sending, by a terminal, first information to a network side device comprises at least one of the following:
periodically sending, by the terminal, the first information to the network side device;
sending, by the terminal when triggered based on the expiry of a first timer, the first information to the network side device, which is triggered based on the expiry of a first timer; or
sending, by the terminal, the first information to the network side device, which is triggered based on a first event.

12. The method according to claim 11, wherein the first event comprises any one of the following:
continuously or cumulatively receiving M1 pieces of backscattering information;
continuously or cumulatively receiving backscattering information for N1 times;
continuously or cumulatively receiving M2 pieces of backscattering information within a first time interval;
continuously or cumulatively receiving backscattering information for N2 times within the first time interval;
M3 pieces of continuous or cumulative unsuccessfully received backscattering information;
N3 times of continuously or cumulatively unsuccessfully receiving backscattering information;
M4 pieces of continuous or cumulative unsuccessfully received backscattering information within a second time interval; or
N4 times of continuously or cumulatively unsuccessfully receiving backscattering information within the second time interval,
wherein M1, M2, M3, M4, N1, N2, N3, and N4 are respectively integers greater than or equal to 1.

13. The method according to claim 11, wherein during the running of the first timer, the terminal does not send the first information, or when the terminal sends the first information, the first timer is restarted.

14. A method for information transmission of backscatter communication, comprising:
receiving, by a network side device, first information sent by a terminal participating in backscatter communication; and
performing, by the network side device, configuration update or transmission adjustment related to backscatter communication based on the first information,
wherein the first information comprises at least one of the following:
inventory-related information;
information related to backscattering of a backscatter device; or
information related to a carrier wave or a control command.

15. The method according to claim 14, wherein the inventory-related information comprises at least one of the following:
a recommended value of Q, wherein Q is a parameter used for managing a response probability of the backscatter device;
a suggested value for increasing Q;
a suggested value for reducing Q;
an expected quantity of backscatter devices controlled by a control command at a time;
a recommended value of N, wherein the terminal reports, after each N rounds of inventory, backscattering information of the backscatter device received by the terminal to the network side device; or
a recommended inventory method.

16. The method according to claim 15, wherein the recommended inventory method comprises at least one of the following:
inventory of a single backscatter device;
inventory of a plurality of backscatter devices; or
whether the terminal participates in sending a specific control command to assist the network side device in performing inventory of a backscatter device.

17. The method according to claim 14, wherein the information related to backscattering of a backscatter device comprises at least one of the following:
information on reception of backscattering information of the backscatter device; or
transmission parameter adjustment information of the backscatter device.

18. The method according to claim 17, wherein the information on reception of backscattering information of the backscatter device comprises at least one of the following:
statistics of a number of times of unsuccessful receptions of the backscattering information;
statistics of a number of times of successful receptions of the backscattering information; or
reason information of unsuccessful reception of the backscattering information.

19. The method according to claim 14, wherein the information related to a carrier wave or a control command comprises at least one of the following:
transmission parameter adjustment information of the carrier wave or the control command; or
format adjustment information of the control command.

20. A terminal, comprising: a memory storing a computer program; and a processor coupled to the memory and configured to execute the computer program to perform operations comprising:
sending first information to a network side device, wherein the first information is used for configuration update or transmission adjustment related to backscatter communication, and the first information comprises at least one of the following:
inventory-related information;
information related to backscattering of a backscatter device; or
information related to a carrier wave or a control command.
